(19) United States
(12) Patent Application Publication
(10) Pub. No.: US 2005/0108553 A1
(43) Pub. Date: May 19, 2005

(54) Time recorder having associated intermittent biometric sensor and comparison apparatus

(76) Inventor: Peter Jakubowski, Huntington Beach, CA (US)

Correspondence Address: Bruce B. Brunda;STETINA BRUNDA GARRED & BRUCKER, 75 Enterprise, Suite 250, Aliso Viejo, CA, 92656, US

(21) Appl. No.: 10/714,196

(22) Filed: Nov. 14, 2003

(51) Int. Cl. H04K 1/00

(52) U.S. Cl. 713/186

(57) ABSTRACT

A time recorder having associated intermittent biometric sensor and comparison apparatus is provided. The time recorder comprises a time recording mechanism for recording the presence of a worker, upon entry of a worker specific identifier at the time recording mechanism. A memory circuit is provided for storing records of worker specific biometric reference data, each record being associated with a worker specific identifier. A biometric sensor operates to sense biometric data associated with the worker present at the sensor. An intermittent comparison circuit operates to intermittently compare the sensed biometric data to the biometric reference data associated with the worker specific identifier entered at the time recording mechanism. A printing circuit or video display circuit operates to generate printed indicia representative of the comparison between the sensed biometric data and the biometric reference data associated with the worker specific identifier entered at the time recording mechanism.

### CROSS-REFERENCE TO RELATED APPLICATIONS

Not Applicable
STATEMENT RE: FEDERALLY SPONSORED RESEARCH/DEVELOPMENT

Not Applicable

### BACKGROUND OF THE INVENTION

The present invention relates to time recorders used to log in and log out individuals at a facility. In their basic form, such time recorders are implemented as time clocks which operate to time stamp a card to indicate the time that a worker is in attendance at a facility.

In a more sophisticated form, the time recorder operates as a computerized device that also can calculate and accumulate hours worked by an individual, based on the programmed payroll policies of a particular company. The time recorder may, for example, separate time and hours worked based upon regular and overtime pay categories. Other types of data collections may be affected to conform to data categories utilized in a company's payroll preparation. In addition, the recorder may function to generate easy-to-read management reports, sorted by categories such as hours or dollars. By such features, the time recorder provides flexibility to account for and control its labor costs.

Conventional time clocks generally presume that the person punching the card is in fact the person identified on the card. However, occasions have been known to occur where a coworker will punch in on his card, and also punch in using a coworker's card, to make it appear that the coworker is on the job, when in fact he is not. Such conduct is commonly referred to as “buddy punching”, which may have various undesirable effects. One obvious disadvantage of buddy punching is that an employer is misled to pay an absent worker for time that the worker is not present at the job site. Job assignments and other daily allocations of labor can also be adversely effected when it ultimately becomes apparent that the coworker is not available to complete his job responsibilities, which may also impact the job responsibilities of others.

Additionally, in the case of an emergency or in the like, the whereabouts of the absent worker may be unknown, causing not only anxiety to family members or the like trying to reach the worker, but also potentially exposing rescue workers to unnecessary danger in the event that an evacuation situation arises and the coworker is unaccounted for.

In short, the problem of buddy punching creates economic, staffing, accounting and safety problems that may be unacceptable to an efficient and accountable organization.

Various technologies exist for confirming the identification of individuals entering a facility. Such devices typically include biometric sensors, of various types, which uniquely identify individuals to confirm who is entering and leaving a facility. Such biometric sensors include fingerprint detectors, palm print detectors, voice detectors, iris detectors and other devices operative to detect, quantify, store and compare data to reference material corresponding to a variety of different individuals. For example, policy departments commonly utilize fingerprint identification systems to identify suspects in an effort to solve a crime. The procedures for identifying suspects typically include comparing a suspect's fingerprints to a database of millions of files, in an effort to find a match. The match is typically confirmed by human comparison of the sample fingerprint to the fingerprints on the computer-identified files. Similar practices of sampling, comparison, and human evaluation are commonly implemented with respect to the various types of biometric sensing/comparing devices.

While such biometric sensing and comparing systems are reasonably accurate, the processing time for such comparisons with file data is typically too long to allow the process to be applicable to high throughput activities, such as clocking in and out of a workplace. For example, the typical cycling time for a time recorder system is about 3 seconds, additional processing time of 3 seconds to 10 seconds or more would reduce the throughput of the time recorder by 50% or much more, depending upon the file size, type of processing, etc. In such cases, the additional burden resulting from the biometric comparison may be wholly unacceptable, and create log jams where workers are trying to clock into or out of a job site.

Accordingly, there exists a need to implement some form of biometric identification of workers entering or leaving a job site, without imposing undue delays at the time recorder locations. By balancing such competing interests, buddy punching problems can be mitigated to substantially lower levels, without imposing processing delays or otherwise demoralizing workers by implementing lengthy identity checks every time they enter or leave a facility.

### BRIEF SUMMARY OF THE INVENTION

A time recorder having associated intermittent biometric sensor and comparison apparatus is provided. The time recorder comprises a time recording mechanism for recording the presence of a worker, upon entry of a worker specific identifier at the time recording mechanism. A memory circuit is provided for storing records of worker specific biometric reference data, each record being associated with a worker specific identifier. A biometric sensor operates to sense biometric data associated with the worker present at the sensor. An intermittent comparison circuit operates to intermittently compare the sensed biometric data to the biometric reference data associated with the worker specific identifier entered at the time recording mechanism. A printing circuit operates to generate printed indicia representative of the comparison between the sensed biometric data and the biometric reference data associated with the worker specific identifier entered at the time recording mechanism.

In various implementations the biometric sensor circuit may be implemented as a fingerprint detection circuit, voice detection circuit, eye feature detection circuit or other biometric censoring devices. A processor is provided regulating the operation of one or more of the time recording mechanism, the biometric sensor, the memory circuit, the printing circuit and/or the intermittent comparison circuit. Alternately, the information generated from the intermittent comparison circuit may be stored in a separate personal computer for processing and printing at a later time. A video display circuit may be used to generate printed indicia representative of the comparison between the sensed biometric data and the biometric reference data associated with the worker specific identifier entered at the time recording mechanism.

The worker specific identifier may be implemented by means of various indicia, magnetic, optical, electronic, etc. The identifier may be applied to various structures, such as an employee badge, a photo identification card, or embedded within an electronic device interrogatable by the time recorder or the time recording mechanism or other circuits.

The intermittent comparison circuit may be constructed to include a variable control circuit, for varying the rate of comparing biometric data, in relation to recording the presence of the worker. For example, the variable control circuit may implement a comparison of biometric data only every tenth time that the time recording mechanism records the presence of a worker. The intermittent comparison circuit may operate to compare biometric data in relation to each time the recording mechanism records the presence of a worker, every other time, or some selected fraction of the time that the time recording mechanism records the presence of a worker. The variable control circuits may alternately operate to vary, randomly or in accordance with a predetermined schedule, the rate at which the comparison circuit compares the biometric data in relation to each time the time recording mechanism records the presence of a worker.

In response to the comparison of biometric data with worker specific identifier, the processor may direct the printer to print a message that the sensed biometric data conforms, or does not conform to the referenced biometric data associated with the worker specific identifier entered at the time recording mechanism. Alternatively/additionally, the processor may instruct the printer to print a message that no comparison has been made between the sensed biometric data and the referenced biometric data associated with the worker specific identifier entered at the time recording mechanism.

### BRIEF DESCRIPTION OF THE DRAWINGS

FIG. 1 is a block diagram illustrating the principal components and functional relationships of the present invention.

FIG. 2 is a block diagram illustrating one implementation of a biometric sensor circuit interface with an external computer and the main board of a time recording mechanism.

FIG. 3 is a flow chart illustrating the process of initially recording reference biometric data files in association with a workers specific identifier.

FIG. 4 is a flow chart illustrating the process of biometric data verification and associated printer functions.

FIG. 5 illustrates a flow chart illustrating one implementation of implementing the present invention utilizing a random numbered generator to determine whether fingerprint verification is to proceed.

### DETAILED DESCRIPTION OF THE INVENTION

In general the invention is directed to an apparatus in process for confirming identification of workers at a job site, in conjunction with clocking in and/or out of the jobsite. In one implementation the invention mitigates a processing time by randomly comparing detected biometric data with file data. As such, only a limited number of workers are actually identified by a comparison of biometric data. However, the uncertainty as to who will be selected for biometric comparison would tend to mitigate buddy punching by significant levels. The frequency or percentage of such biometric comparisons, in relation to all workers entering a facility, may also be selected and varied, either randomly or in accordance with the schedule. For example, on Monday the identity of 10% of workers entering a facility may be confirmed by biometric comparison. On Tuesday, only 5% of the workers may be subject to such identity checks.

In one implementation the invention implements an identity check in conjunction with some employee identification media, such as an employment card or badge. As such, the identification badge may be provided with a magnetic strip, optical strip, or the like to identify the alleged identity of the worker. The identification media may be utilized to access biometric data associated with that worker, which may then be compared to data collected by the biometric sensor. In accordance with this technique, the biometric sensor data need not be compared with the entire database of similar types of data, but only to the data corresponding to the worker identified by the worker's card or badge. In this way the processing time is significantly reduced, as well as prospects for false positives or false negatives in the data comparison.

Where the comparison indicates some discrepancy between the worker's alleged identity and comparison of biometric data, the time recorder may be operative to provide indicia on the timecard indicating that no match exists. Under such circumstances the worker would typically be required to have a supervisor sign the card, preferably within a limited time window, to confirm the worker's identity, notwithstanding the biometric discrepancy.

The time recorder may also provide indicia on the time card indicating either that no biometric match was conducted at that time, or that a biometric match was successfully completed.

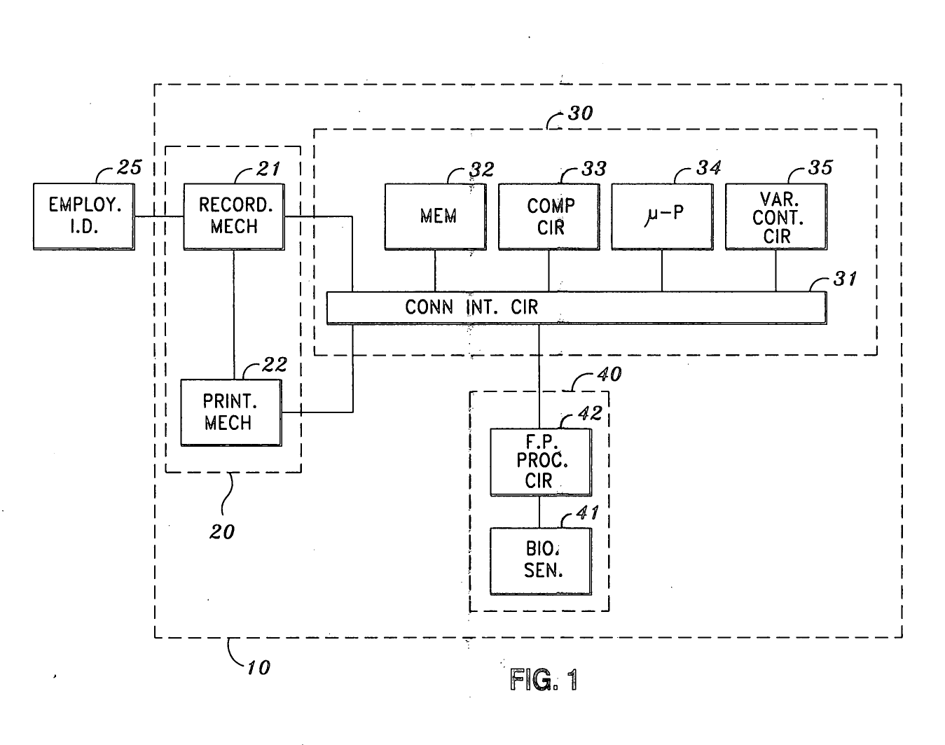

Referring to FIG. 1 a block diagram is provided which illustrates the basic structures and functions of the present invention. As shown there in FIG. 1, intermittent biometric time recorder 10 includes time recorder 20, finger sensor circuit 40, comparison circuit 30. The basic time recorder 20 includes time recording mechanism 21, a and printing circuit 21. Both the time recording mechanism 21 and priting circuit 21 can communicate between each other and the communication interface circuit 31 to the comparison circuit 30. The time recording mechanism 13 and printing circuit 21 may be implemented as a commercially available computerized time recorder, such as the MJR-8000N-8150 Time Recorder marketed by Amano Cincinnati, the assignee of the present application. That device is operative to perform a variety of recording and accounting functions for hundreds of employees. The device calculates and accumulates hours worked and separates hours into regular and overtime hours. The device includes flexible programming options such as rounding, grace periods and the like, and programmably prints identification information and other information on a card inserted within the device.

The biometric sensor circuit 41 may be a variety of different types of biometric sensors, such as fingerprint detection circuit, a voice detection circuit, or an eye feature detection circuit, such as an iris pattern detection circuit. When the biometric sensor is implemented as a fingerprint detection circuit, suitable devices to implement the function of the circuit include the Siemens TopSec ID Fingerprint Detection Module, or the Secugen FDA01 Fingerprint Detection Module. The fingerprint sensor may that may be associated with a fingerprint processing circuit 42 to collectively form a fingerprint sensor circuit 40. Fingerprint sensor circuit 40 is in electrical communication with communication interface circuit 31.

Reference biometric data is stored within a memory 32, which may be a portion of comparison circuit 30. The comparison circuit 30 may also include processor 34 and comparison circuit 33, all in electrical communication through communication interface circuit 31. As will be apparent to those skilled in the art, the functions of memory 32 and comparator circuit 33 may be controlled by or implemented within the processor 34.

A variable control circuit 35 may also be provided to regulate the functions of processor 34. In particular, the variable control circuit 35, which is in electrical communication with communication interface circuit 31, may be useful to select or modify the rate at which biometric data comparison proceeds, in relation to each time a worker's specific identifier 25 is entered into the time recording mechanism 21. The variable control circuit 35 may, for example, enable a biometric data comparison each time an employee identifier is entered into the time recorded mechanism, every other time, every tenth time, or in accordance with some programmable or random frequency. In one implementation the variable control circuit 35 will randomly sample biometric data, consistent with the fixed or variable percentage of time that an employee identifier is entered to the time recording mechanism.

As one of ordinary skill will recognize, the employee identifier 25 may be implemented as many different types of employees specific indicia. Identifier 25 may comprise a time card, an employee badge, a worker identifier card, such as a photo identification card, or as an identifier including an interrogatable electronic device, e.g. interrogatable in response to an electronic interrogation signal.

In general, the system 10 shown at FIG. 1 operates in accordance with a contemporary time recorder the majority of the time. However, in some cases the system operates to require a user to enter biometric data at the sensor 41, which is compared to referenced biometric data in memory 32, which is associated with the worker identified by the worker associated with the identifier 25. In the event the sensed biometric data from sensor 41 conforms with the worker specific biometric data stored in memory 32, system operates to provide an indication of such conformity, enabling printer 22 to note that conformity, and complete the clock-in/clock-out operation. Printer circuit 22 may be directed to print alternate messages as directed by time recording mechanism 21 and/or comparison circuit 30. It is to be understood that the invention is not intended to be limited in relation to particular communication protocols between time recorder 20 and comparison circuit 30. Nor is it intended to be limited with respect to the content of information communicated between time recorder 20 and comparison circuit 30. Further, the invention is not intended to be limited with respect to the distribution of processing resources within the system to more efficiently communicate information and instructions within the system.

It is also anticipated that various implementations of selectively enabling biometric data comparisons.

In a generally unpredictable manner will similarly provide a deterrence of buddy punching or other potential abuses that is likely to be greater then simply the number of detected abuses, and does not consume the resources, nor create the traffic problems that are more likely to be associated with biometric detection systems that are not sequenced in a generally random manner. Such concerns are particularly applicable for time clock applications, as in the present invention. As such, the present invention allows the practical application of biometric sensor circuits in operative association with time recorder mechanisms.

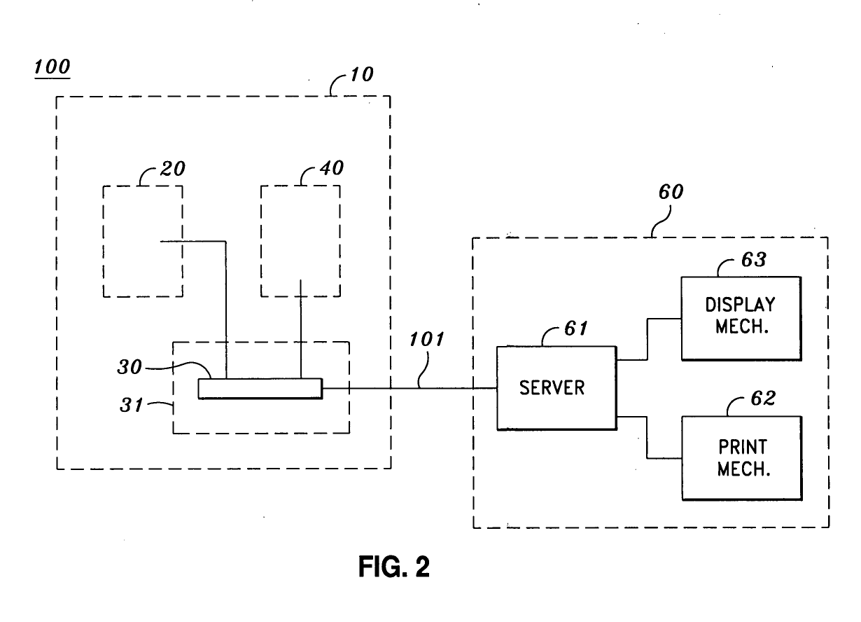

FIG. 2 is a block diagram of an intermittent time recording system 100 made up of the intermittent biometric time recorder 10 and an external computer 60. FIG. 2 illustrates an interface between modules of the time recorder 20, fingerprint sensor circuit 40 and the comparison circuit 30, all in electrical communication through communication interface circuit 31, and the external computer system 60. (FIG. 1). As shown at FIG. 2, finger sensor circuit 40 communicates with communication interface circuit 31. The communication interface circuit 31 communicates both addresses and data 9. The time recorder 20, and comparison circuit 30 including The communication interface circuit 31 may be implemented within a time recorder, such as the above referenced Amano Cincinnati MJR Time Recorder.

The communication interface circuit 31 also communicates with computer system 60. The computer 61 operates to enable communication interface circuit 31 to sample biometric data from fingerprint sensor circuit 40. After the biometric data has been sampled and compared to worker specific biometric reference data, the computer 61 may operate to enable an employee or person-being-monitored information to be transferred via communication link 101 back to the communication interface circuit 31, for execution of printing, display and other functions at the time recorder 10. Computer 61 may also operate a printer 62 or video display 63 in order to print the indicia representative of the comparison between the sensed biometric data and the biometric reference data associated with the worker specific identifier entered at the time recording mechanism on paper or a video screen.

The data from the fingerprint sensor circuit 40 and time recorder 20 can be communicated through the communication interface circuit 31 via communication link 101 to the computer system 60. The computer 61 can then process this data and output it to a separate printer 62 or a video terminal 63.

In the presently preferred implementation the interface communication circuit contains:
1. a connector for RS-232 DB25 Connector;
2. a RS-485 Terminal Block;
3. drivers for the RS-232/485 Communication;
4. LEDs for communication status and fingerprint operation; and
5. a micro-controller, which is able to perform three asynchronous serial communication ports. One port is interfacing with the main board containing the time recorder 20, and comparison circuit 30, one port with the host PC computer 61 and the last one to the finger sensor circuit 40. In other applications, it is anticipated that system 100 would further include an Ethernet board and a modem board, to facilitate additional communications options.

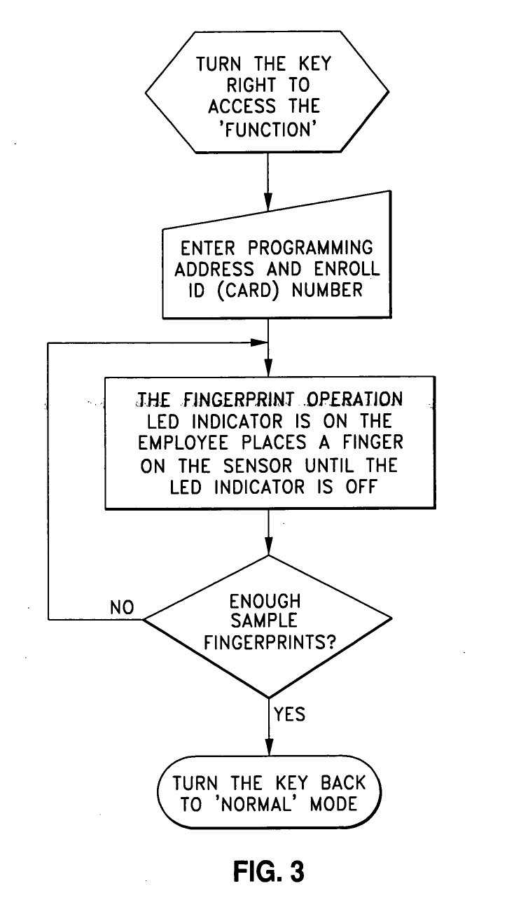

FIG. 3 is a block diagram implementing a process of storing biometric reference information for subsequent comparison in accordance with the present invention. This process is commonly known as enrollment. As shown therein the technique includes entering worker specific data or indicia, such as employee identification number, in combination with sample biometric data from the same person. The information may be maintained in the memory circuit, such as memory circuit 32 (FIG. 1).

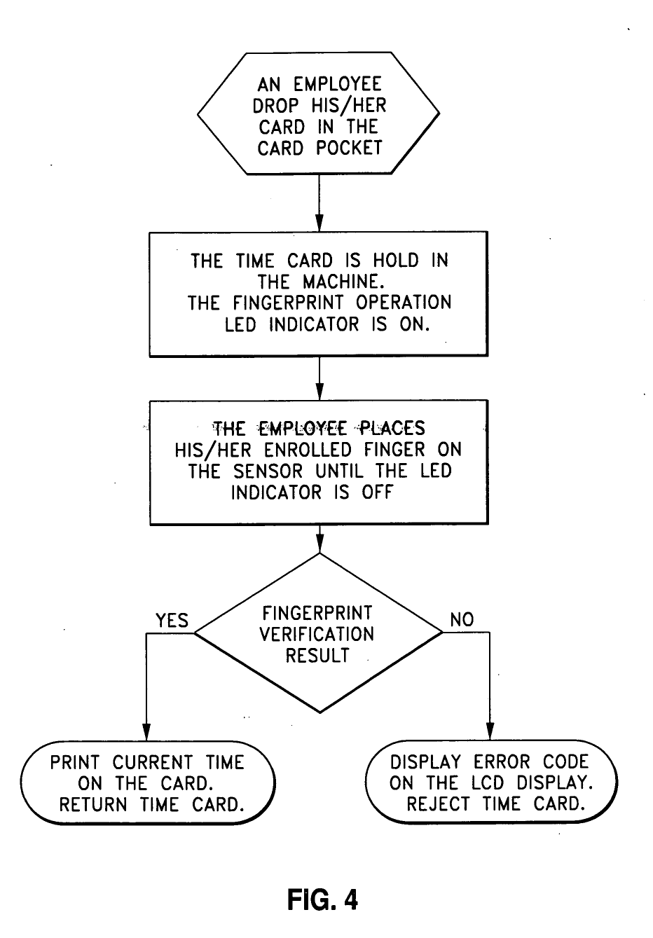

FIG. 4 illustrates an exemplary punch-in/out procedure, implemented in accordance with the present invention without the random fingerprint verification algorithm employed. An employee may insert an identification card, or the equivalent in to a card pocket formed in the time recorder. As the time card is held in the recorder, a fingerprint operation LED indicator will turn on, indicating that the person should place their fingerprint on the biometric sensor.

When the biometric detection proceeds, the employee may place his/her enrolled finger(s) on the sensor to enable verification with reference biometric data associated with the employee identified by the identification card.

Where the comparison indicates that the detected biometric data conforms with the reference biometric data, a positive fingerprint verification results, whereupon the time recorder may print current time on the card, along with verification or validation data, and return the time card.

Where the detected biometric data does not conform with the reference biometric data error codes and messages may be printed on a display associated with the time recorder, which also may reject the time card.

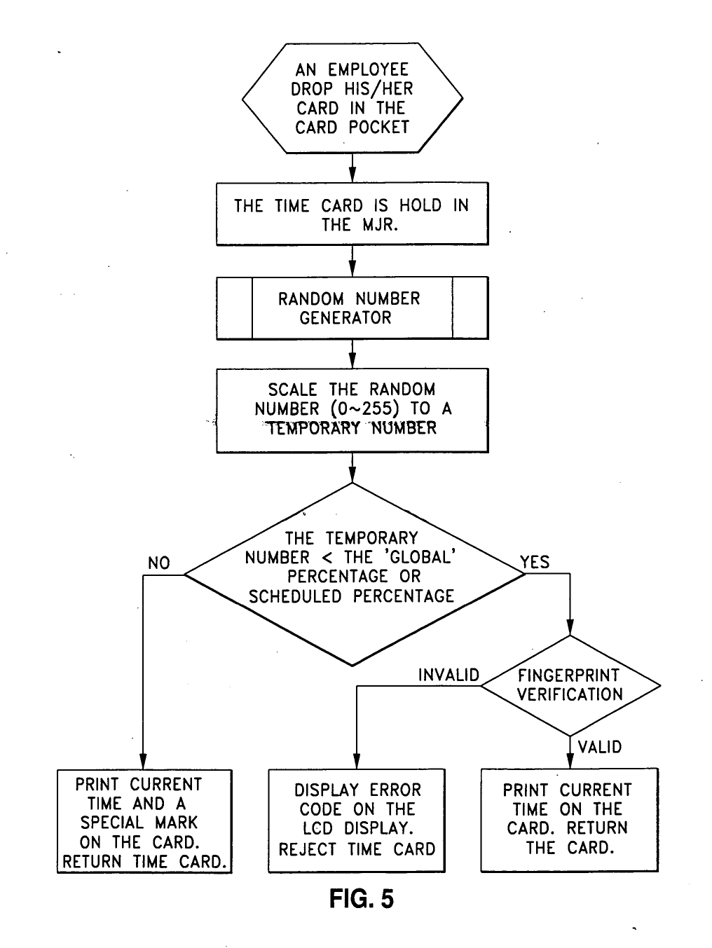

FIG. 5 illustrates a flow chart illustrating one implementation of implementing the present invention utilizing a random numbered generator to determine whether fingerprint verification is to proceed. Where the fingerprint verification does not proceed a special mark may be noted on the time card, indicating that the entry or exit was not secured by biometric data comparison.

It should be understood by those skilled in the art that the integration of a random number generator in the present invention may be implemented in various ways and within different structures, leading to a common result of intermittently validating biometric data associated with time card users. The invention is therefore not intended to be limited by a particular implementation of a random numbered generator, or the particular use of a random numbered generator to intermittently validate biometric data.

As noted above the present invention may be implemented in various embodiments, which perform the same or equivalent functions as the embodiments disclosed and set forth above, in connection with the drawings. To the extent operating consistent with the present invention such alternate embodiments are considered to be within the scope and spirit of the present invention as set forth herein.

1. A time recorder having associated intermittent biometric sensor and comparison apparatus comprising:
a. a time recording mechanism for recording the presence of a worker upon entry of a worker specific identifier at the time recording mechanism;
b. a memory circuit for storing records of worker specific biometric reference data, each record being associated with a worker specific identifier;
c. a biometric sensor operative to sense biometric data associated with a worker present at the sensor;
d. an intermittent comparison circuit, for intermittently comparing the sensed biometric data to the biometric reference data associated with the worker specific identifier entered at the time recording mechanism; and
e. an indicator circuit operative to generate indicia representative of the comparison between the sensed biometric data and the biometric reference data associated with the worker specific identifier entered at the time recording mechanism.

2. The time recorder as recited in claim 1 wherein the indicator circuit is a printer to generate the visible indicia.

3. The time recorder as recited in claim 2 wherein the biometric sensor circuit is a fingerprint detection circuit.

4. The time recorder as recited in claim 2 wherein the biometric sensor circuit is a voice detection circuit.

5. The time recorder as recited in claim 2 wherein the biometric sensor circuit is an eye feature detection circuit.

6. The time recorder as recited in claim 2 wherein the intermittent comparison circuit includes a variable control circuit for varying the rate of comparing the biometric data in relation to recording the presence of the worker.

7. The time recorder as recited in claim 2 further comprising a processor operatively associated with the time recording mechanism, for regulating operation of the time recording mechanism in response to an instruction set operating in the processor.

8. The time recorder as recited in claim 7 wherein the processor regulates the operation of the biometric sensor.

9. The time recorder as recited in claim 8 wherein the processor regulates the operation of the memory circuit.

10. The time recorder as recited in claim 9 wherein the intermittent sampling circuit is implemented by the processor.

11. The time recorder as recited in claim 7 wherein the processor regulates the operation of the printing circuit.

12. The time recorder as recited in claim 10 wherein the processor instructs the printer circuit to print a message that sensed biometric data from the worker conforms to referenced biometric data associated with the worker specific identifier entered at the time recording mechanism.

13. The time recorder as recited in claim 10 wherein the processor instructs the printer circuit to print a message that sensed biometric data from the worker does not conform to referenced biometric data associated with the worker specific identifier entered at the time recording mechanism.

14. The time recorder as recited in claim 10 wherein the processor instructs the printer circuit to print a message that no comparison has been made between the sensed biometric data and referenced biometric data associated with the worker specific identifier entered at the time recording mechanism.

15. The time recorder as recited in claim 1 wherein the indicator circuit is a display monitor to generate the visible indicia.

16. The time recorder as recited in claim 15 wherein the processor instructs the printer circuit to print a message that sensed biometric data from the worker conforms to referenced biometric data associated with the worker specific identifier entered at the time recording mechanism.

17. The time recorder as recited in claim 15 wherein the processor instructs the printer circuit to print a message that sensed biometric data from the worker does not conform to referenced biometric data associated with the worker specific identifier entered at the time recording mechanism.

18. The time recorder as recited in claim 15 wherein the processor instructs the printer circuit to print a message that no comparison has been made between the sensed biometric data and referenced biometric data associated with the worker specific identifier entered at the time recording mechanism. The time recorder as recited in claim 1 wherein the worker specific identifier is applied to an employee badge.

19. The time recorder as recited in claim 1 wherein the worker specific identifier is applied to an identification card.

20. The time recorder as recited in claim 19 wherein the identification card is a timecard.

21. The time recorder as recited in claim 1 wherein the worker specific identifier is an interrogatable electronic device.
